(19) United States
(12) Patent Application Publication
(10) Pub. No.: US 2012/0041775 A1
(43) Pub. Date: Feb. 16, 2012

(54) SYSTEMS, METHODS, AND COMPUTER PROGRAM PRODUCTS FOR PATIENT MONITORING

(75) Inventors: Daniel L. Cosentino, Chaska, MN (US); Christopher T. Abrahamson, Bloomington, MN (US); Kristin N. Parrott, Jordan, MN (US)

(73) Assignee: Cardiocom, LLC, Chanhassen, MN (US)

(21) Appl. No.: 13/112,276

(22) Filed: May 20, 2011

Related U.S. Application Data
(63) Continuation-in-part of application No. 12/854,452, filed on Aug. 11, 2010.

(51) Int. Cl. G06Q 50/00

(52) U.S. Cl. 705/2

(57) ABSTRACT

Software, or a pathway assistant, can be utilized to facilitate assessment or treatment recommendations of a remotely monitored patient and can run in the background. The pathway assistant, which searches data for key information and creates pathways, provides an automated system that standardized the assessment, treatment, management and evaluation of patients being monitored. The pathways generated allow a user, nurse, or caregiver, to follow precise instructions and assessing a patient's condition. The pathways software limits human error associated with assessment and provide more cost-effective management for large patient populations thus providing an advantage over prior art. Collecting data for the software may be performed by an interactive voice response (IVR) system. The patient may dial the IVR system or the IVR system may be configured to call the patient at predefined times.

### CROSS REFERENCE TO RELATED APPLICATION

This application is a continuation-in-part of U.S. patent application Ser. No. 12/854,452 entitled “Systems, Methods, and Computer Program Products for Patient Monitoring” to Cosentino et al., filed Aug. 11, 2010.

### TECHNICAL FIELD

The present disclosure is directed, generally, to wellness monitoring devices and, more specifically, to measuring devices that monitor patients with a disease or condition.

### BACKGROUND

There are a number of diseases and health-related conditions that are known to be associated with certain physiological parameters, including weight change due to fluid gain or loss. Non-limiting examples of diseases and conditions associated with fluid retention and associated weight change include kidney disease, congestive heart failure (CHF), cirrhosis of the liver, lymphatic obstruction, lymphedema, certain medications, and pre-eclampsia.

Chronic Kidney Disease (CKD), also known as chronic renal failure, includes a progressive loss of renal function over a period of months or years. CKD includes all individuals with kidney damage, as well as all individuals with a glomerular filtration rate (GFR) of less than 60 mL/min/1.73 m² for 3 months, irrespective of the presence or absence of kidney damage.

CKD is often divided into a series of five stages. Stage-five CKD, often referred to as End Stage Renal Disease (ESRD), includes patients with established kidney failure such as those with a GFR<15 mL/min/1.73 m², or those patients who require permanent renal replacement therapy. ESRD patients are usually treated by drugs, dialysis, and/or kidney transplant. Type 2 diabetes mellitus is the most common cause of ESRD in the U.S. Diabetic nephropathy is believed responsible for at least 25% of all renal dialysis patients. Other common causes of ESRD include hypertension and glomerulonephritis.

ESRD symptoms include weight change, such as weight gain due to fluid retention in the patient's tissues or weight loss. A measure of the patient's weight change is often used as an indicator of the patient's condition, where a weight above a threshold or below a threshold may require medical intervention, such as dialysis or drug therapy. Consistent monitoring of a patient's weight and application of appropriate treatment can minimize a patient's decline, reduce risk of re-hospitalization, and/or improve quality of life.

Conventional systems exist to monitor a patient from his or her home without the need for an in-home healthcare provider. However, such systems are unable to facilitate diagnosis and treatment. Therefore, improvements are desirable.

### BRIEF SUMMARY

According to an example embodiment, a method performed by a computerized weight measurement device comprises receiving data indicative of a weight. The weight is compared to a first weight parameter and a second weight parameter, generating information relevant to End Stage Renal Disease (ESRD) from comparing the weight to at least one of the first and second parameters. Output is then provided that includes the generated information.

Software, or a pathway assistant, can be utilized to facilitate assessment and treatment recommendations of a remotely monitored patient and can run in the background. The pathway assistant, which searches data for key information and creates pathways or roadmaps, provides an automated system for standardized assessment, treatment, and evaluation of patients being monitored. The pathways generated allow a user, nurse, or caregiver, to follow precise instructions for assessing a patient's condition. The pathways software limits human error associated with assessment thus providing an advantage over prior art. The pathways software also facilitates highly scalable, cost effective monitoring. Using the pathways software 1 Nurse can manage hundreds or even thousands of patients. Typically, staffing ratios can be increased from 1 Nurse:75 patients to 1 Nurse:500+ patients.

A second embodiment is a system which comprises a scale measuring a weight of a patient. The scale includes a processor-based device with a memory which stores a first weight parameter and a second weight parameter relevant to ESRD. The processor-based device compares the weight of the patient to the first and second weight parameters and provides patient feedback based on the comparison.

Another embodiment consists of a computer program product having a computer readable medium having computer program logic recorded thereon for monitoring a patient. The computer program product comprises code for facilitating assessment and treatment, including critical pathways.

Yet another embodiment is a system for monitoring ESRD that comprises means for measuring a weight of a patient, means for comparing the weight of the patient to a plurality of weight parameters relevant to ESRD, and means for providing output consistent with the comparing the weight of the patient to the plurality of parameters.

In another example embodiment, a method includes receiving data indicative of a physiological parameter; scanning the data; determining if any of the data matches pre-defined criteria, and if any of the data matches pre-defined criteria, then generating a medical pathway for assessment by a user; and providing output including the medial pathway; wherein the user can follow the medical pathway to assess, educate, intervene, or provide treatment recommendations to the patient; or notify a remote health care provider of the patient status.

In another example embodiment, a system for assessment of remotely monitored patients includes a receive module for receiving data from remote monitoring devices; a pathways module for generating medical pathways based on the data received; and a management module for managing a plurality of medical pathways.

According to an example embodiment, a method may include initiating a call between a patient and an interactive voice response (IVR) system. The method may also include authenticating the patient on the call. The method may further include collecting data from the patient after authenticating the patient. The method may also include performing risk assessment of the patient based, in part, on the collected data.

In another example embodiment, a system includes an authentication module for authenticating a patient for accessing an interactive voice response (IVR) system. The system also includes a text-to-speech module for providing prompts to the patient. The system further includes a data collection module for receiving responses to the prompts from the patient. The system also includes a risk assessment module for evaluating the responses received by the data collection module.

In yet another example embodiment, an apparatus includes a processor coupled to a memory device, in which the processor is configured to initiate a call with a patient. The processor is also configured to authenticate the patient. The processor is further configured to collect data from the patient. The processor is also configured to perform risk assessment of the patient from the collected data.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is an illustration of an exemplary system for monitoring patient wellness, adapted according to one example embodiment;

FIG. 2 is an illustration of an exemplary operational flow performed by a monitoring device according to one example embodiment;

FIG. 3 is a block diagram of an exemplary monitoring device adapted according to one example embodiment;

FIG. 4 is an illustration of an exemplary integrated monitoring device, such as may include the features shown in FIG. 3 to provide patient monitoring, according to one example embodiment;

FIG. 5 is an illustration of an exemplary integrated monitoring device, such as may include the features shown in FIG. 3 to provide patient monitoring, according to one example embodiment;

FIG. 6 is operational flow diagram of a pathways software, according to an example embodiment;

FIG. 7 is an example screen shot of a global queue, according to an example embodiment;

FIG. 8 is an example screen shot of a member queue, according to an example embodiment;

FIG. 9 is an example screen shot of a open pathways screen, according to an example embodiment;

FIG. 10 is an example screen shot of an assessment category, according to an example embodiment;

FIG. 11 is an example screen shot of a guide me screen, according to an example embodiment;

FIG. 12 is an example screen shot of a notes field, according to an example embodiment;

FIG. 13 is an example screen shot of a summary field, according to an example embodiment;

FIG. 14 is an example screen shot of a triggered rules field, according to an example embodiment; and

FIG. 15 is an example screen shot of a closed pathway field, according to an example embodiment.

FIG. 16 is an example screen shot of a pathway summary, according to an example embodiment.

FIG. 17 is a flow chart illustrating setting up a patient for access to an IVR system according to an example embodiment.

FIG. 18 is a flow chart illustrating authentication of a patient in an IVR system according to one embodiment.

FIG. 19 is an example screen shot of message selection for an IVR system according to an example embodiment.

FIG. 20 is an example screen shot of custom message entry for an IVR system according to an example embodiment.

FIG. 21 is an example screen shot illustrating assignable numeric values to questions for risk stratification according to an example embodiment.

FIG. 22 is an example screen shot illustrating glucose alerts configurable for patients of the IVR system according to an example embodiment.

FIG. 23 is an example screen shot illustrating configuration of administrators according to an example embodiment.

FIG. 24 is an example screen shot illustrating a graphical view of patient health information according to an example embodiment.

FIG. 25 is an example screen shot illustrating a tabular view of patient health information according to an example embodiment.

FIG. 26 is an example screen shot illustrating an administrator dashboard summary according to an example embodiment.

FIG. 27 is an example screen shot illustrating biometric alerts according to an example embodiment.

### DETAILED DESCRIPTION

In general software, or a pathway assistant, can be utilized to facilitate assessment or treatment recommendations of a remotely monitored patient and can run in the background. The pathway assistant, which searches data for key information and creates pathways, provides an automated system that standardized the assessment, treatment, and evaluation of patients being monitored. The pathways generated allow a user, nurse, or caregiver, to follow precise instructions and assessing a patient's condition. The pathways software limits human error associated with assessment and significantly increase efficiencies for managing large dialysis patient populations (hundreds of thousands of dialysis patients) thus providing an advantage over prior art.

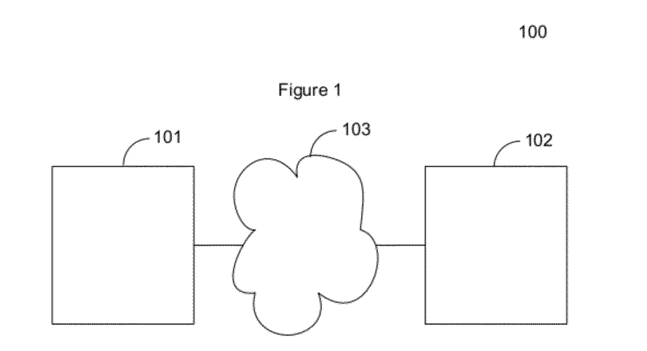

FIG. 1 is an illustration of the exemplary system 100 for monitoring patient wellness, adapted according to one embodiment. Physiological data of a patient is monitored utilizing a monitoring apparatus 101 and output is provided to the patient, caregiver, a remote computer 102, and/or a health care provider. Data generated from the monitoring is transmitted to the remote computer 102 via a communication network 103. In one embodiment, patient data contemplated for transmission includes a patient's weight but might include any physiological parameter answers to questions, or other data. Patient data may also include other data from the monitoring, such as blood pressure, electrocardiogram, fluid intake, fluid output, bio impedance, blood glucose, symptoms related to ESRD, and the like. The remote computer 102 may be, for example, at a facility for a health care provider, a dialysis treatment center, where a nurse, physician or nurse practitioner monitors the patient data and provokes treatment in accordance with such data. Similarly, in various embodiments, the monitoring apparatus 101 is located at a healthcare facility, a dialysis treatment center, a patient's residence, or other location convenient to the patient. Additionally, in some embodiments, the monitoring apparatus 101 includes processes that present messages to a patient informing the patient of the results of the monitoring, inviting the patient to contact a health care professional, accelerate their dialysis treatment schedule, or instructing the patient to modify drug, diet or care plan, ask the patient certain questions, and the like.

In the examples below, the monitoring apparatus includes a weighing device, such as a scale that has a processor and memory operably configured to compare the patient's weight with various parameters relevant to ESRD, or other conditions, and to perform one or more processes to facilitate the patient's treatment. Operation of the monitoring apparatus 101 and communication therewith are described in more detail below.

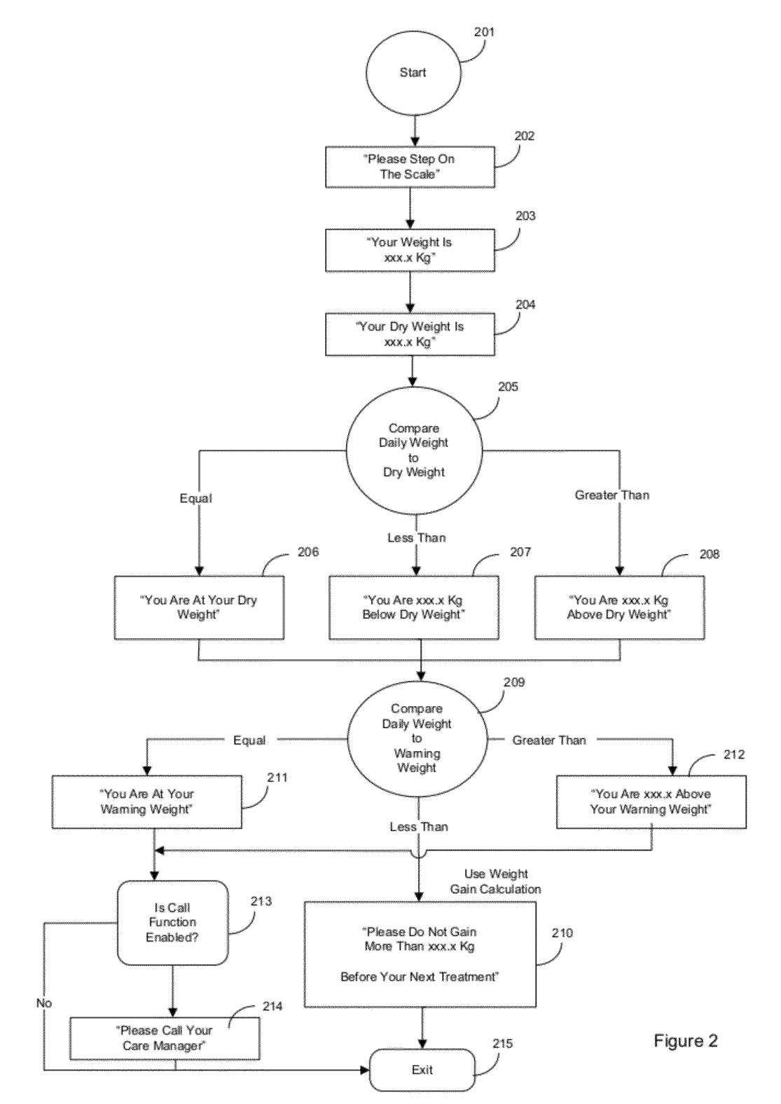

FIG. 2 is an illustration of an exemplary operational flow diagram 200 performed by a monitoring device according to one example embodiment. For instance, the monitoring device 101 (FIG. 1) can be adapted to perform the operational flow 200.

The operational flow 200 begins at 201. At block 202, the monitoring device presents a message (e.g., on a computer screen or other type of screen) imploring the user to step on the scale. When the user ascends the scale, the monitoring device, using one or more transducers, measures the weight of the patient. At block 203, the monitoring device presents a message in response to the patient's stepping on the scale, where the message gives the patient's weight (also referred to below as “daily weight”). The monitoring device may also calculate and/or store the patient's dry weight with a date and time. In the examples below, the dry weight is one parameter used to assess the condition or fluid status of the patient. The dry weight may be set, remotely or otherwise, by a health care provider familiar with the patient's condition. At block 204, a message is presented giving the patient's dry weight.

The monitoring device compares the patient's weight to the patient's dry weight at block 205. If the patient's weight is substantially equal to the patient's dry weight, the monitoring device presents a message to the patient to that effect at block 206. If the patient's weight differs from the patient's dry weight, the patient receives a message informing the patient of the difference at one of blocks 207 and 208.

Alternatively after block 203 the process can start at block 209, whereby the patient's weight is compared to the patient's warning weight to derive information about the patient's condition. The warning weight, in this example, includes a high weight limit of the patient and may be calculated by the monitoring device or set, remotely or otherwise, by a health care provider. In one example, the warning weight is a number equal to a mean pre-dialysis weight plus a constant, as shown in Equation (1).

Warning Weight=(mean pre dialysis weight over past 30 days)+1 Kg (1)

Should the patient's weight be below the patient's warning weight, such condition is usually a good indication for the patient. Accordingly, the patient is shown a message informing the patient to continue to control his or her weight, but no alarm or exception is issued for the warning weight parameter. In one embodiment, the monitoring device uses a weight gain calculation, such as that shown in Equation (2) in order to formulate the message of block 210. The operational flow 200 then exits at block 215.

Weight Gain=(Warning Weight−1 Kg)−Daily Weight (2)

On the other hand, should the patient's weight be at or above the warning weight, the patient is informed of such condition. Specifically, if the patient's weight is at the warning weight, a message to that effect is presented to the patient at block 211. Similarly, if the patient's weight is above the warning weight, a message to that effect is presented to the patient at block 212.

If the patient is at or above his or her warning weight, the operational flow 200 advances to block 213 where it is discerned whether the monitoring device has an enabled call function. If the call function is not enabled, then the operational flow 200 exits at block 215. If the call function is enabled, then the patient is presented a message at block 214 to call his or her health care provider. In some embodiments, the message is interactive (e.g., using a touchscreen or keypad), allowing the patient to establish the call. In other embodiments, the call may be placed automatically. In other embodiments, the patient could be provided with specific dialysis care plan or treatment instructions. In addition, questions may be asked of the patient to aid in diagnosing the patient's condition. The operational flow exits at block 215.

The operational flow 200 is especially useful in monitoring ESRD patients. For instance, comparing a patient's weight to the dry weight and/or the warning weight provides some reference as to the patient's interdialytic weight gain (IDWG). This is important as excessive interdialytic weight gain (IDWG) is usually related to an overload of sodium and water, and is an important factor for arterial hypertension in dialysis, which may accelerate left ventricular remodeling and increase risk for cardiovascular events and death.

Various embodiments may use other parameters in addition to, or alternatively to, a dry weight and a warning weight, e.g., a lower weight limit for a patient equal shown in Equation (3). Furthermore, various embodiments may modify one or more of dry weight and warning weight from the descriptions given above or monitor other physiological parameters.

Minimum Weight=(mean post dialysis weight in past 30 days)−1 Kg (3)

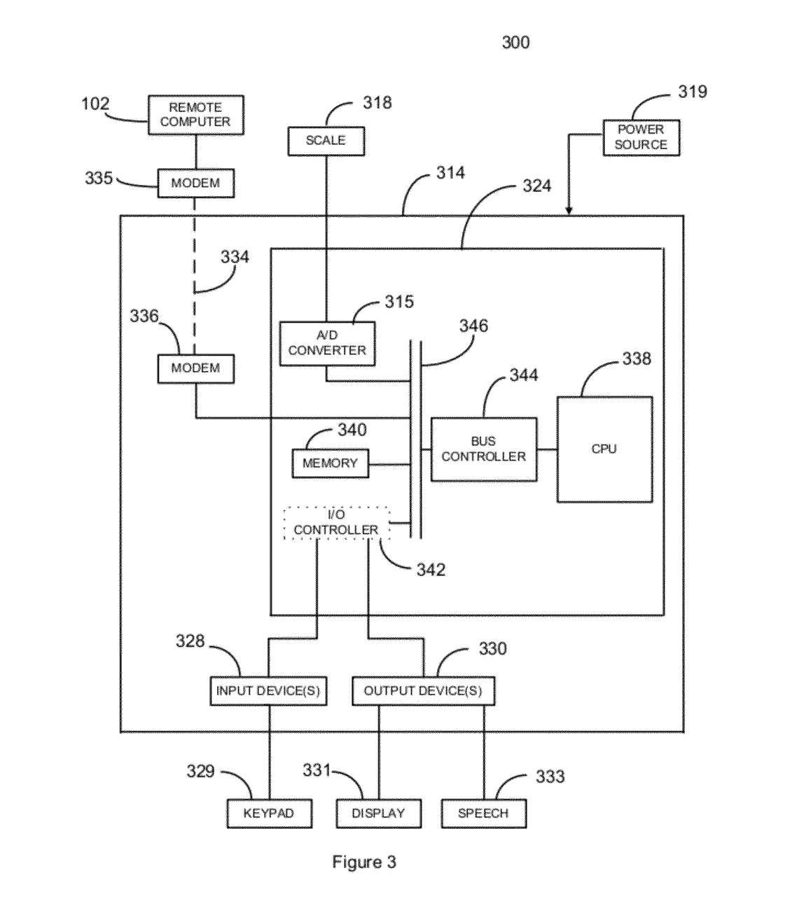

Communication is established with the remote device 102 (FIG. 1) to transmit data consistent with the comparison at block 209 and/or at block 205 and/or any other information relevant to the patient's wellness, i.e. answers to questions asked. Once communication is established with the remote device, the information is transferred and analysis of the data can be performed. In addition, a health care provider can provide treatment to the patient by, e.g., initiating automatic processes in the monitoring device (e.g., taking blood pressure or presenting a questionnaire), scheduling a nurse or doctor visit, and the like. The content and timing of the communication is discussed in more detail with respect to FIG. 3 below.

FIG. 2 shows various messages presented to a user, and some of the messages can be interactive. Other embodiments may present messages using a different medium (e.g., audio and/or video), a different format (e.g., using different measuring units or languages) or, even, different substance. Any message that may be useful to present to a patient may be presented in various embodiments. For instance, Table 1 provides a non-exclusive list of message alternatives that may be adapted for use in the operational flow 200. The messages can be used to gain information from the patient regarding the patient's symptoms and status. Answers to the questions can then be transmitted to the remote device 102 (FIG. 1).

TABLE 1

| Category | Message |
|---|---|
| Provider | Do you want your nurse to call you? |
| | Do you need a call from your nurse? |
| Device Scripts | Please call your Care Manager |
| | Please call your Nephrologist |
| | Please call your Kidney Doctor |
| | Please call your Dialysis Unit |
| | Please call your Doctor |
| | For emergencies call your doctor or 911 |
| Weight Comparison | Your Dry Weight is |
| | You are at your Dry Weight |
| | You are at your Weight Limit |
| | You are at your Low Warning Weight |
| | You are at your Minimum Weight |
| | You are at your Warning Weight |
| | You are |
| | Below Dry Weight |
| | Above Dry Weight |
| | Above your Weight Limit |
| | Below your Weight Limit |
| | Above your Warning Weight |
| | Below your Warning Weight |
| | Above your Minimum Weight |
| | Below your Minimum Weight |
| | Above your Low Warning Weight |
| | Below your Low Warning Weight |
| Gain | You should not gain more than_{——}_{——}_{——} |
| | Try not to gain more than_{——}_{——}_{——}_{——} |
| | Please do not gain more than_{——}_{——}_{———} |
| | Before your next treatment_{——}_{——}_{——}_{———} |

Additionally, in some embodiments, the monitoring device may present one or more interactive messages in Table 2 as a standard question set, where questions answered positively generate an exception (reported to the remote device 102) regardless of a symptom score that may be assigned and where scores can be changed at a later date. In fact, the scope of embodiments is not limited to the monitoring of ESRD, as functionality to monitor other diseases may be additionally included in some embodiments. In one example, a Telescale® monitoring device, available from Cardiocom, LLC, which is operable to monitor symptoms of diseases such as congestive heart failure, is modified to additionally include functionality to perform the operational flow 200 of FIG. 2 and to include some or all content of Tables 1 and 2. A Telescale® monitoring device is described in U.S. Pat. No. 6,290,646, which is incorporated herein by reference in its entirety. An important aspect of the invention is a library of interactive messages and education statements for ESRD patients that are focused on a broad range of topics including, but not limited to: access management, fistula and graft options, infection and wound identification and management, adherence with dialysis treatment schedules, compliance with fluid intake restrictions, general dialysis treatment options (home hemodialysis, peritoneal dialysis), and transplant options. Such interactive messages may be included in the question set of one embodiment, where the interactive messages also include the co-morbidities of ESRD such as CHF, hypertension and diabetes, which are important in the integrated care for dialysis patients.

TABLE 2

| # | Symptom | Abbreviated Sample Question List | Score |
|---|---|---|---|
| 1 | SOB | Are you feeling short of breath? (If | 4 |
| | | yes, ask all 3 questions below) | |
| | | More short of breath than normal? | 3 |
| | | Are you short of breath at rest? | 3 |
| | | Are you getting enough air? | 2 |
| | | | (Acute) |
| 2 | Fever | Do you feel feverish or have chills? | 3 |
| | | (If yes, ask question below) | |
| | | Is your temperature above 99 degrees? | 3 |
| 3 | Infection | Do you have a sore or an open wound? | 2 |
| | | (If yes, ask all 3 questions below) | |
| | | Is it new? | 2 |
| | | Is it red or draining? | 3 |
| | | Is it healing? | 1 |
| 4 | General | Do you have any new health concerns? | 2 |
| | Health | | |
| 5 | Access | Are you having any problems with your | 3 |
| | | dialysis access? | |
| | | Are you having any redness, swelling | 4 |
| | | or pain at your access site? | |
| 6 | Provider | Would you like a call from your | 2 |
| | | dialysis nurse? | |
| | | For emergencies call your doctor or | |
| | | 911 | |
| 7 | Medications | Are you taking all your medication? | 1 |
| | | (If no, ask both questions below) | |
| | | Are you out of any medication? | 1 |
| | | Do you have any medication concerns? | 1 |

FIG. 3 is a block diagram of an exemplary monitoring device 300 adapted according to one embodiment and operable to perform the functions described above with respect to FIG. 2. A microprocessor system 324 including a CPU 338, a memory 340, an optional input/output (I/O) controller 342 and a bus controller 344 is illustrated. It will be appreciated that the microprocessor system 324 is available in a wide variety of configurations and is based on CPU chips such as a general purpose processor, an Application Specific Integrated Circuit (ASIC), a Digital Signal Processor (DSP), a multi-core chip package, and/or the like.

In this example, the memory 340 includes computer-executable code therein, which when executed, causes the CPU 338 to perform functions consistent with that shown in FIG. 2 and other functions described herein. When implemented via computer-executable instructions, various elements of embodiments are in essence the software or firmware code defining the operations of such various elements. The executable instructions may be obtained from the memory 340, which includes a tangible readable medium (e.g., a hard drive media, optical media, RAM, EPROM, EEPROM, tape media, cartridge media, flash memory, ROM, memory stick, and/or the like). In fact, readable media can include any medium that can store information.

The monitoring device 300 may be powered in any of a variety of ways, such as by ordinary household A/C line power, DC batteries, rechargeable batteries, and/or the like. Power source 319 provides electrical power for operating the electronic devices. A power source for operating the electronic scale 318 is generated within the housing, however those skilled in the art will recognize that a separate power supply may be provided or the power source 319 may be adapted to provide the proper voltage or current for operating the electronic scale 318.

The housing 314 includes a microprocessor system 324, an electronic receiver/transmitter communication device such as a modem 336, an input device 328 and an output device 330. The modem 336 is operatively coupled to the microprocessor system 324 via the electronic bus 346, and to the remote computer 102 via a communication network 334 and modem 335. The communication network 334 may be any communication network such as the telephone network, wide area network or Internet. It will be appreciated that the modem 336 may include a generally well known product commercially available in a variety of configurations operating at a variety of BAUD rates for dial-up or high-speed Internet access.

The output device(s) 330 are interfaced with the microprocessor system 324. These output devices 330 include a visual electronic display device 331 and/or a synthetic speech device 333. Electronic display devices 331 are well known in the art and are available in a variety of technologies such as vacuum fluorescent, liquid crystal or Light Emitting Diode (LED). The patient reads alphanumeric data as it scrolls on the electronic display device 331, which in some embodiments, may include a touch-screen device that interacts with the patient by sensing touch. Output devices 330 include a synthetic speech output device 333 such as a Chipcorder manufactured by ISD (part No. 4003), or direct wav. file or sound file playback by digital to analog converter, but may also include a speech-input and recognition device. Still, other output devices 330 include pacemaker data input devices, drug infusion pumps, home dialysis equipment or transformer coupled transmitters.

The messages shown in FIG. 2 and Tables 1-3 can be presented audibly or on a user interface presented on the display device 331. It will be appreciated that input device(s) 328 may be interfaced with the microprocessor system 324 and may be included additionally to, or alternatively to, a touchscreen. In one embodiment an electronic keypad 329 is provided for the patient to enter responses into the monitoring apparatus. Patient data entered through the electronic keypad 329 may be scrolled on the electronic display 331 or played back on the synthetic speech device 333. Patient input may also be audibly received through the speech device 333 in some configurations.

The microprocessor system 324 is operatively coupled to the modem 336, the input device(s) 328 and the output device(s) 330. The electronic scale 318 is operatively coupled to the central system 324. Electronic measurement signals from the electronic scale 318 are processed by the A/D converter 315. This digitized representation of the measured signal is then interfaced to the CPU 338 via the electronic bus 346 and the bus controller 344. In one embodiment of the invention, the physiological transducing device includes the electronic scale 318. The electronic scale 318 may include one or more of the following elements: load cells, pressure transducers, linear variable differential transformers (LVDTs), capacitance coupled sensors, strain gages and semiconductor strain gages. These devices convert the patient's weight into a useable electronic signal that is representative of the patient's weight. The electronic scale 318 is generally well known and commercially available, and any compatible electronic scale now known or later developed can be used in various embodiments.

Furthermore, an A/D converter 315 may be included within the scale 318 or within the microprocessor system 324 or within the housing 314. One skilled in the art has a variety of design choices in interfacing a transducing device comprising an electronic sensor or transducer with the microprocessor system 324.

The scale 318 may provide an analog or digital electronic signal output depending on the particular type chosen. If the electronic scale 318 provides an analog output signal in response to a weight input, the analog signal is converted to a digital signal via the A/D converter 315. The digital signal is then interfaced with the electronic bus 346 and the CPU 338. If the electronic scale 318 provides a digital output signal in response to a weight input, the digital signal may be interfaced with electronic bus 346 and the CPU 338. Furthermore, an internal A/D converter connected to a transducer, such as a pressure sensor, can be used to provide pressure information to the CPU for blood pressure measurement.

As will be appreciated by those skilled in the art, various embodiments may differ from the configuration shown in FIG. 3. For instance, the communication path including modems 335 and 336 may be supplemented by, or replaced by, a wireless communication path operable to communicate over one or more networks, such as an IEEE 802.11 network or a 3G or 4G cellular network. Furthermore, various embodiments may include more or fewer transducers or transducers of different types than that shown in FIG. 3 while still performing functions the same as, or similar to, that shown in FIG. 2.

During operation, the monitoring device 300 presents a message, such as that shown in block 202 of FIG. 2, inviting the patient to ascend the scale 318. The patient's weight is measured and compared to parameters by the CPU system 324. Additionally, one or more interactive messages may be presented to the user via the output devices 330, 331, 333 to inform the user of the user's weight status, blood pressure, and/or to inquire about other health factors. Examples of interactive messages to inquire about health factors are shown in Tables 1-2, above. The user interacts with the monitoring device 300 by using the keypad, the display 331 (in the case of a touchscreen), and/or the speech module 333 (if the speech module 333 includes input-receiving functionality) to answer the interactive messages.

Communication with the remote computer 102 (e.g., located at a health care provider facility) may be initiated by the monitoring device 300 automatically in some embodiments. In one example, when an exception is issued, such as by an answer to an interactive question or by a weight measurement at or above a warning weight, the monitoring device automatically alerts the remote computer 102 to the exception or may automatically alert a care giver. In another scenario, the patient's weight data, blood pressure or other vital signs, exceptions, and/or answers to interactive messages are automatically transmitted to the remote computer 102 as they are generated. Establishment of communication can be automatic, periodic, exception-driven, patient-initiated, remote computer 1020-initiated, and/or the like.

In one example, the patient's weight data, blood pressure, or other vital signs, exceptions, and/or answers to interactive messages are transmitted to the remote computer 102, where such information is further analyzed and/or processed. Upon uploading the information to the remote computer 102, a medical professional caregiver may telephone the patient to discuss, clarify or validate any particular wellness parameter or physiological data point. In addition, particular software is used to facilitate further assessment or treatment recommendations as will be explained in more detail below. The conversation may be carried out over a telephone network by a conventional telephone device (not shown) or over the computer network 103 (FIG. 1) using the speech device 333 and a computer network telephony technology, such as Voice Over IP (VoIP). Furthermore, the medical professional caregiver may update the list of wellness parameter questions listed in Tables 1-3 from the remote computer 102 over the two-way communication network 103 (FIG. 1). The modified query list is then stored in the memory 340 of the microprocessor system 324.

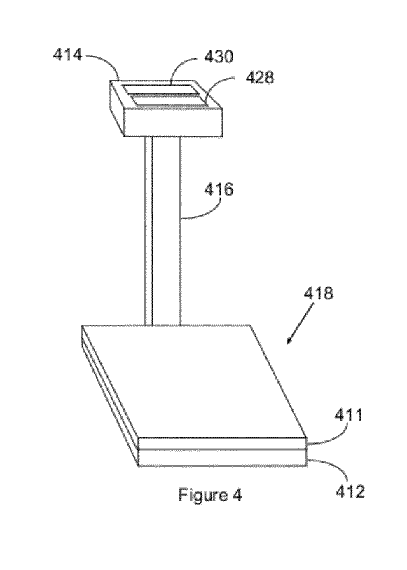

FIG. 4 is an illustration of an exemplary integrated monitoring device 400, such as may include the features shown in FIG. 3 to provide patient monitoring. The integrated monitoring device 400 includes an electronic scale 418. The electronic scale 418 further includes a top plate 411 and a base plate 412. The integrated monitoring device 400 further includes a housing 414 and a support member 416. The base plate 412 is connected to the housing 414 through the support member 416. The housing 414 further includes output device(s) 430 and input device(s) 428. The integrated monitoring device 400 is integrated as a single unit with the support member coupling the base plate 412 and the housing 414, thus providing a unit in a one piece construction. An example scale is described in U.S. Pat. No. 7,577,475, which is incorporated herein by reference in its entirety.

It will be appreciated that other physiological transducing devices can be utilized in addition to the electronic scale 418. For example, blood pressure measurement apparatus and electrocardiogram (EKG) measurement apparatus can be utilized with the integrated monitoring device 400 for recordation and/or transmission of blood pressure and EKG measurements to a remote location. It will be appreciated that other monitoring devices, such as blood glucose, oxygen saturation, bio impedance, and other physiological body functions that provide an analog or digital electronic output may be utilized with the integrated monitoring device 400. Furthermore, various embodiments may provide enhanced transportability and compactness by, for example, making one or parts foldable and/or making the support member 416 telescoping.

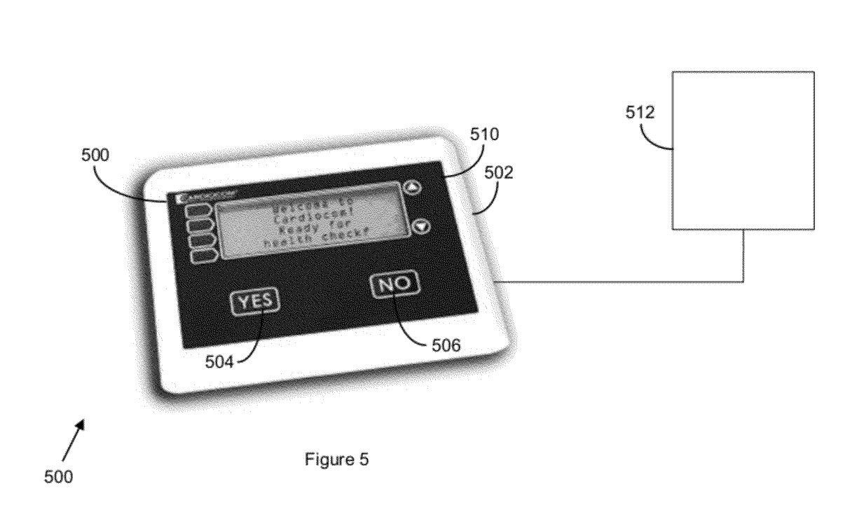

FIG. 5 is an illustration of an exemplary integrated monitoring device 500, such as may include the features shown in FIG. 3 to provide patient monitoring. The integrated monitoring device 500 includes a monitoring console 502. The console 502 preferably includes a “yes” button 504 and a “no” button 506 for interacting and answering questions posed to the patient. The console 502 preferably also includes scroll buttons 510 for scrolling and other buttons 508. Additional buttons may be included for multiple choice and survey questions. The console can be connected to a physiological measuring device 512. The physiological measuring device can be any device capable of measuring or monitoring a physiological parameter, such as a blood pressure monitor, a pulse oximeter, a scale, a glucose meter, a peak flow meter for measuring lung capacity, and the like.

While the embodiments of FIGS. 4 and 5 are shown as stand-alone units, the scope of embodiments is not so limited, as other embodiments may differ somewhat in configuration. In one example, the calculating and communication functionality is included in a general purpose computer that is in communication with one or more peripheral physiological transducing devices.

The following is an example list of terminology and/or equations that may be useful.

| | |
|---|---|
| Terminology | |
| Daily Weight = | Weight recorded that day |
| Warning Weight = | High weight limit of the patient |
| Dry Weight = | Estimated Dry Weight of patient from dialysis |
| | facility order or from order of other health |
| | care provider |
| Minimum Weight | Low weight limit of the patient |
| (LCL) = | |
| Weight XY = | Max weight gain/day |
| Weight Gain = | Weight left until patient gets close to |
| | Warning Weight |
| Pre Dialysis | Patient weight before dialysis measured by |
| Weight = | dialysis unit |
| Post Dialysis | Patient weight after dialysis measure by |
| Weight = | dialysis unit |
| Interdialytic | difference between Pre Dialysis weight and |
| Weight Gain = | last Post Dialysis weight |
| Equations | |
| Warning Weight = | (mean pre dialysis weight over past |
| | 30 days) + 1 Kg |
| Estimated Dry | Ordered by physician |
| Weight = | |
| Minimum Weight = | (mean post dialysis weight in past |
| | 30 days) − 1 Kg |
| Weight XY = | (Maximum interdialytic weight gain in past |
| | 30 days + 1 Kg)/3 |
| Weight Gain = | (Warning weight − 1 Kg) − daily weight |

In general, software, or a pathway assistant, can be utilized to facilitate diagnosis or treatment of a remotely monitored patient and can run in the background. The pathway assistant, which searches patient data for key information and creates pathways, provides an automated system that standardized the diagnosis, assessment, treatment, evaluation and management of patients being monitored. The pathways generated allow a user, nurse, or caregiver, to follow precise instructions for assessing a patient's condition. The pathways software limits human error associated with assessment and provides more efficient, large population management thus providing an advantage over prior art.

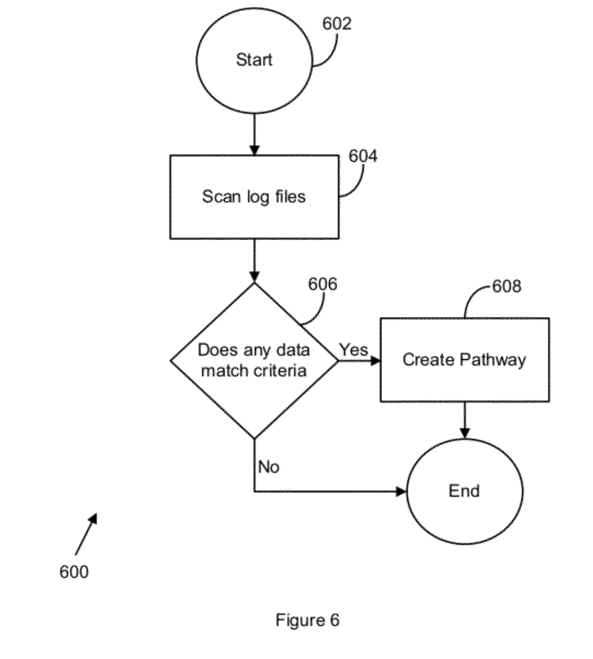

Referring to FIG. 6, a logic flow diagram is provided for creating a pathway 600, such as a pathway for diagnosing or treating a patient. Operational flow starts at block 602. A scan module 604 scans new log files received from, for example, a remote monitoring device or other remote data source (i.e. dialysis treatment center lab values). A determine module 606 determines if any data in the new log files matches pre-defined data. If the determine module 606 determines that data does match pre-defined data, operational flow branches “YES” to a pathway module 608 that creates a pathway for assessment by a user, nurse, or care giver. Operational flow ends at block 610. Referring to the determine module 606, if the determine module 606 determines that no data matches, operational flow branches “NO” to the end block 610, and no corresponding pathway is created.

Preferably, the pathway assistant searches for key types of activities that include real time biometric/symptomatic alert pathways, upcoming scheduled pathway activities/events, or other data driven patient or population specific elements. When a specified criteria is met, a pathway is generated and assigned to the patient. For example, when a monitoring apparatus 101 connects with a remote computer 102 and transmits information the remote computer 201, a device log is created which describes the types of data that has been received, for example, weight, PEFR, SPO2, Glucose, Blood Pressure, Heart Rate, and Health Check responses. The pathway assistant scans this device log for pre-selected criteria, and when matches are found, the associated pathway is created and assigned to a patient.

The pathway generated by the assistant is different from standard alerts in that they allow for more granularity in the areas of recurrence and trending. The pathway itself creates a standardized methodology for dealing with episodes and out of scope symptoms, biometrics or lab values. In other words, the pathway provides a roadmap for a caregiver to follow to ensure that correct assessment and treatment recommendations are provided. The pathway is advantageous because it facilitates assessment and treatment of patients in a standardized methodology that limits human error.

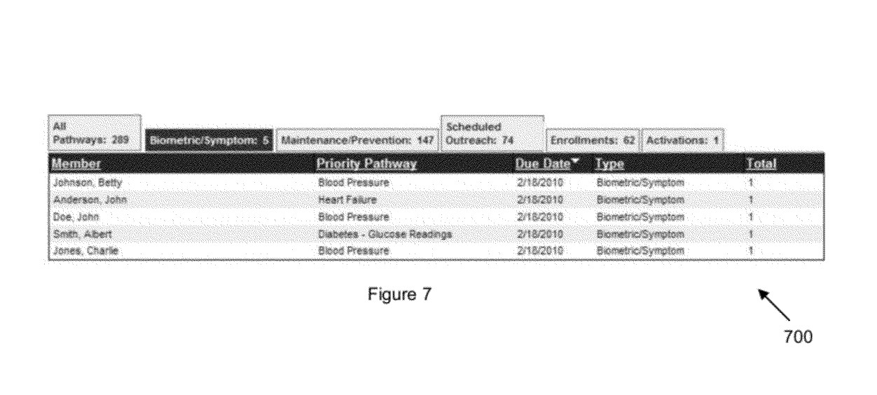

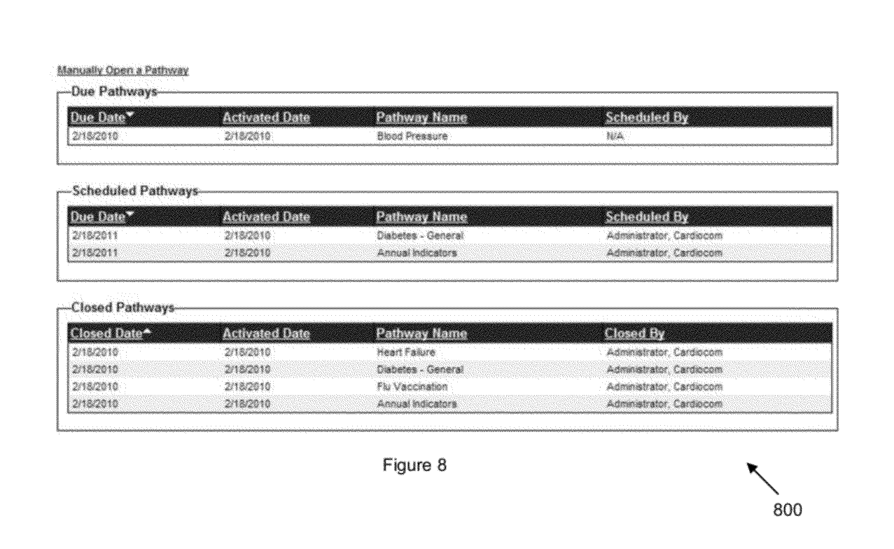

The caregiver simply follows the roadmap and fills in the appropriate information and follows the appropriate instructions as provided by the pathway. The pathway assistant also creates pathways for upcoming scheduled events. These events are not alert events but normal regular follow-up or maintenance. This type of pathway is created in a “suspended” state, meaning that it is not active or in need of immediate attention. On the due date of the schedule, the pathway automatically moves to an active status to indicate it is in need of attention. An example of a scheduled event might include annual medication assessments, QOL surveys, or flu shot reminders. Once this pathway is closed the assistant will create a new one with the scheduled date set to the next predefined date interval (months, weeks, or days). Pathways can be triggered by referencing multiple variables. Some of these variables include: vital signs or symptoms transmitted by a monitoring device; predefined schedules, manually by a user, lab values, or dialysis treatment values. The pathways can be organized for better handling. FIG. 7 is an example of a global pathways work queue 700. This global queue 700 lists all the current pathways. FIG. 8 is an example of a member pathways work queue 800. This member queue 800 lists all the current pathways for a particular member. From the global pathways work queue 700, a user can select a member to go to the member queue 800. From here, a user can choose to manually open a pathway, open a pathway that is “due”, open a “scheduled” pathway, or view closed pathways.

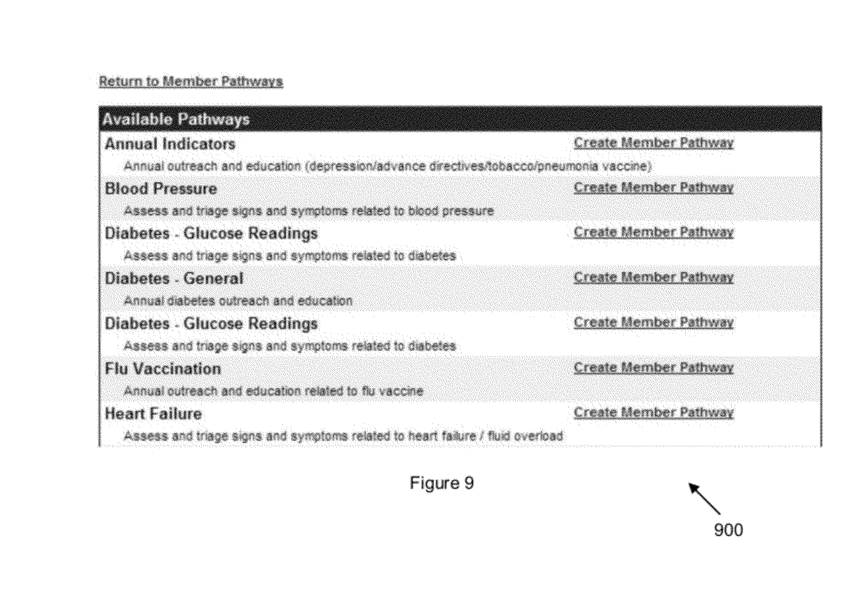

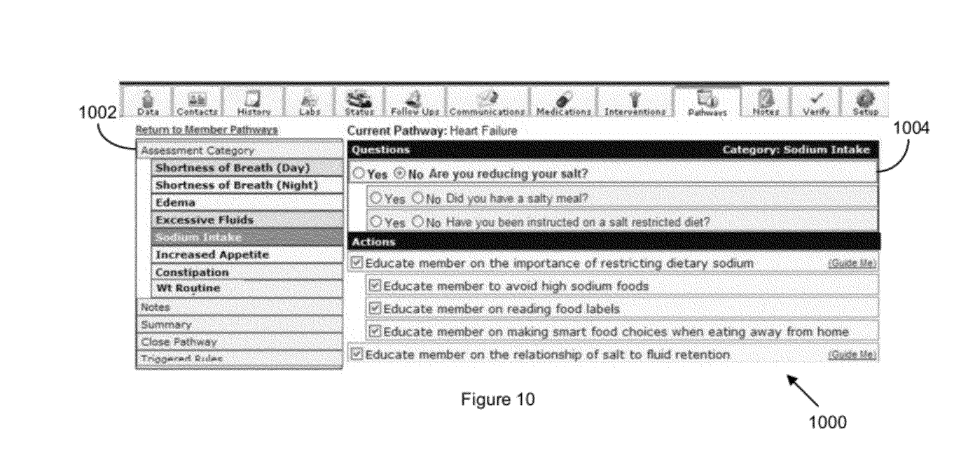

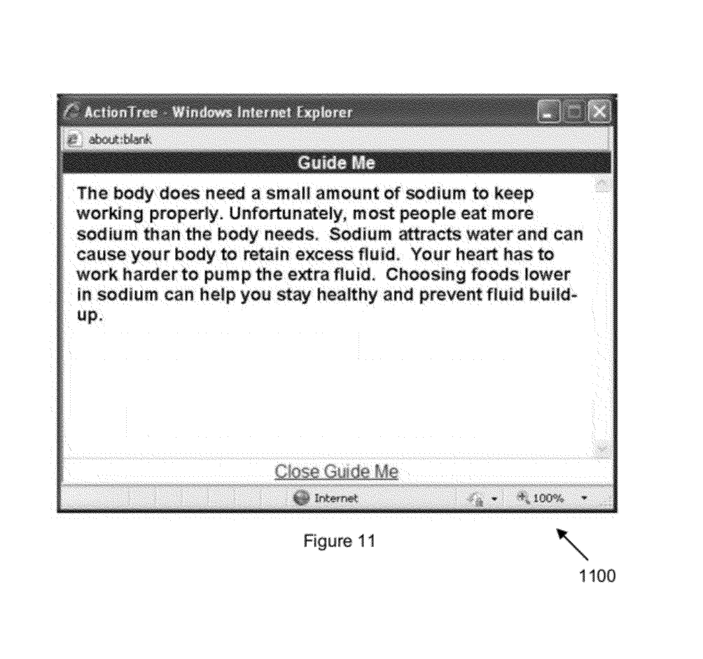

FIG. 9 is an example screen shot 900 for manually opening a pathway and provides a listing of available pathways. FIG. 10 is an example of a member pathway 1000. Each pathway 1000 has certain assessment categories 1002. In this example, the categories are color coded to facilitate use by a user. Red categories have an alert or positive response to a question. Green categories have a response that is normal or expected. Blue categories indicate a category that has not yet been addressed. Each category has certain “questions” 1004 to be asked and the answers recorded. It is noted that the pathway includes the possible answers. An example question to be asked is “did you have a salty meal?” and the available answers are yes or no. The user can populate the correct answer. Each question has the possibility to have corresponding actions, or secondary pathways, based on the answer. Questions and actions can have “guide me” links that open to provide detailed educational content 1100, as illustrated in FIG. 11. Question and action selection is point and click on the requested boxes or radio buttons. Questions and actions have branching logic built-in. For example, if you select “YES” to a certain question, the pathway may automatically populate with additional questions. Actions can be programmed to be optional or required.

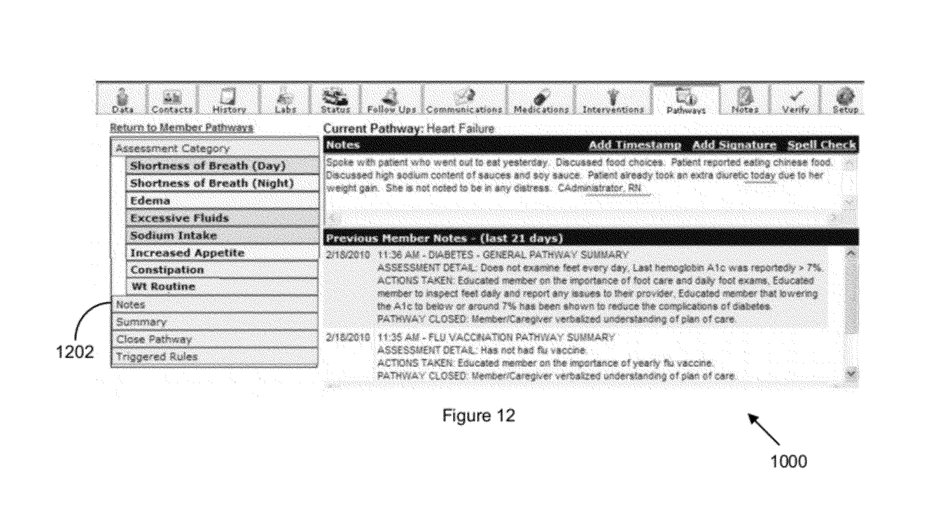

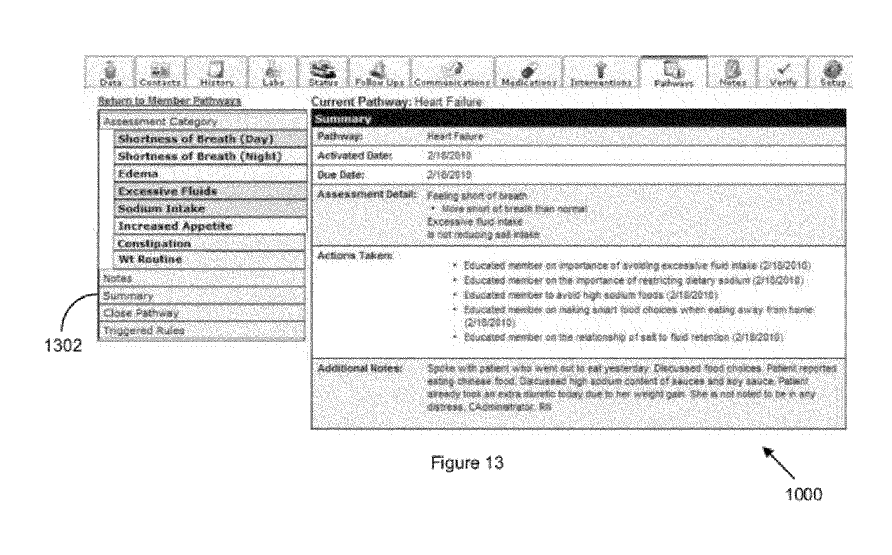

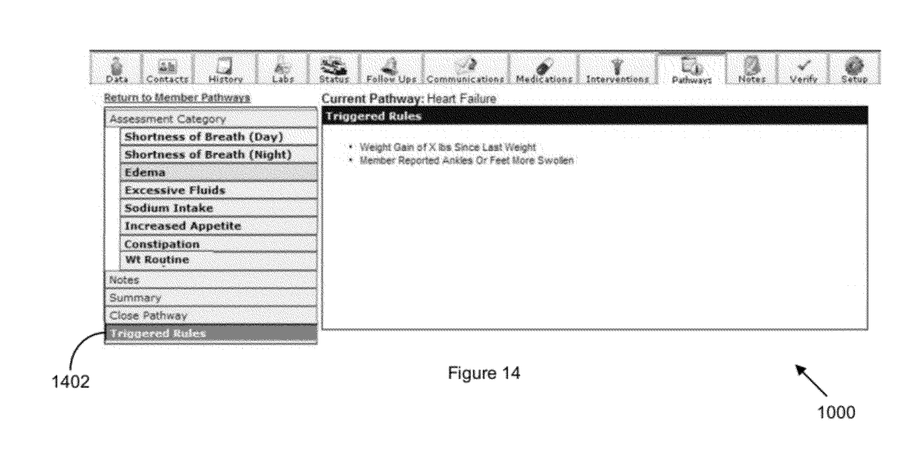

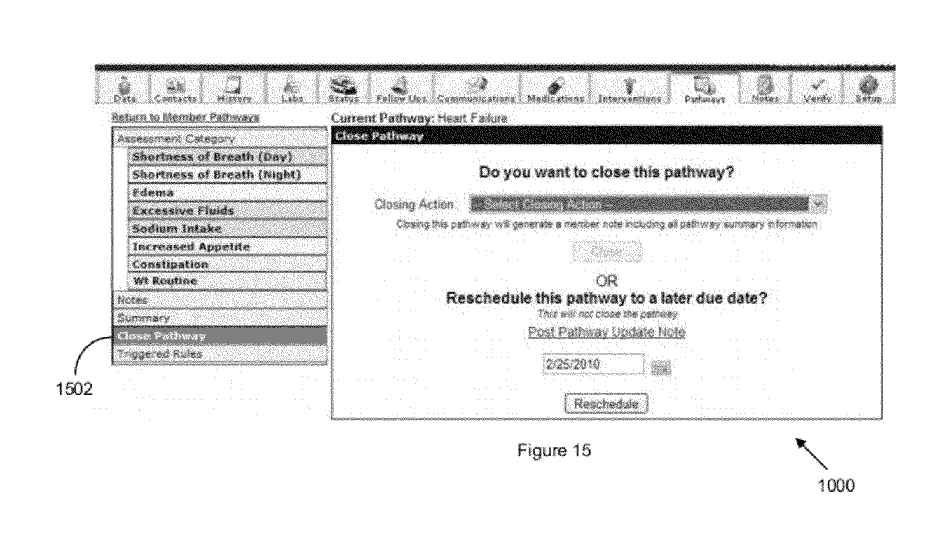

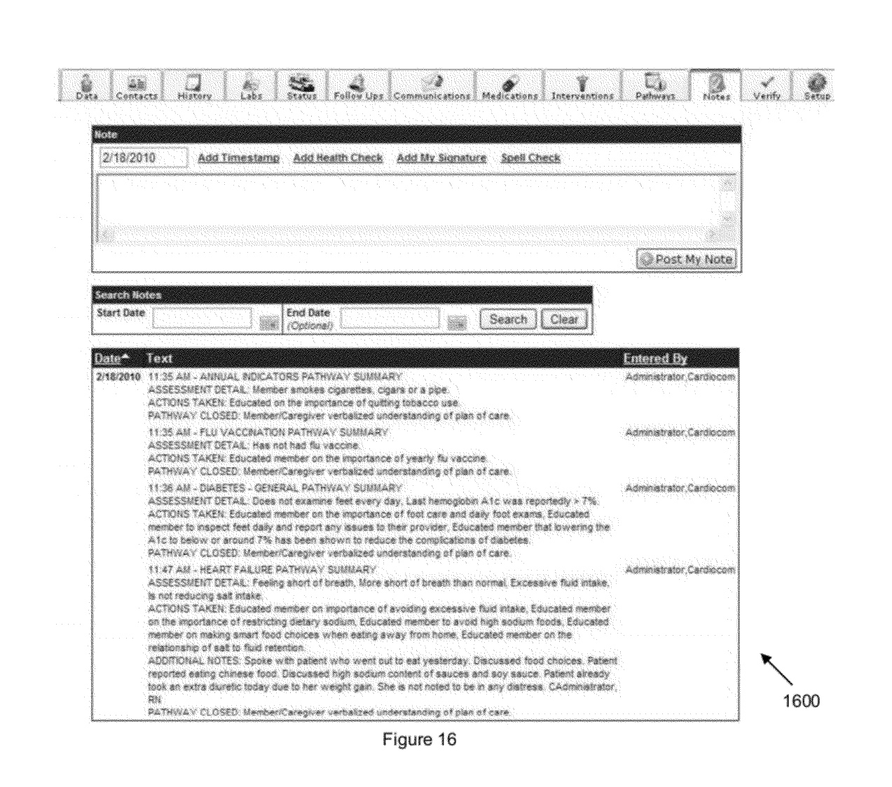

Referring to FIG. 12, each pathway 1000 has a Notes filed 1202 where a user can freelance notes and see previous notes. Referring to FIG. 13, each pathway 1000 has a “Summary” 1302 where a user can view a summary of the pathway. The summary is preferably dynamically built when the user selects questions and actions and documents standardized text notes. Referring to FIG. 14, each pathway 1000 has a “triggered rules” 1402 section where a user can view the rules that triggered the pathway. Referring to FIG. 15, each pathway 1000 has a “close pathway” 1502 section. A user can select a “closing action” and the “close” button will become enabled as long as all required documentation is completed in the pathway. A user can also reschedule the pathway with a new due date in the future. The pathway will stay open, but now be displayed in the “scheduled pathways” section in the member pathway work queue. Referring to FIG. 16, when a user closes a pathway, the system generates a “Pathway Summary” note 1600 that includes all of the details for that pathway.

In addition to the collection of data by devices illustrated in, for example, FIGS. 4-5, data may be collected by a telephone system such as an interactive voice response (IVR) system. An IVR system allows patients to call into a system using their telephone without any additional equipment. The IVR system prompts the patient with questions and allows the patient to respond with a voice response and/or a touch-tone keypad response. The responses may be made available to clinicians and/or administrators immediately during the call or after the patient's telephone call has ended. In one embodiment, the IVR system may be designed to call patients at predetermined times. Thus, the IVR system may perform regular check-ups on patients and/or check-in on patients who have not called in for a certain period of time.

An IVR system provides administrators with information useful to the diagnosis of or care of patients in an efficient manner. For example, administrators may obtain more frequent knowledge of a patient's health status than otherwise possible with patient visits to an administrator's office. The additional data may be analyzed to detect trends or trigger pathways as described above with reference to FIG. 6. Additionally, the IVR system may prevent unnecessary hospitalizations or emergency room visits by providing the patient with immediate information or instructions for their care. When the patient is prescribed a care plan involving routing check-ins or care tasks, the IVR system may proactively call the patient and encourage adherence to the care plan. The care plan may be part of a chronic disease management protocol.

According to one embodiment, an IVR system may provide access to previously collected data, diagnostic information, and/or behavioral suggestions for patients communicating with the IVR system. For example, a patient may be able to ask “what-if” questions to the IVR system and the IVR system may respond with answers to educate the patient. Additionally, the IVR system may provide automatic feedback to a patient based on their response to prompts from the IVR system. For example, the IVR system may provide guidance regarding a patient's weight based on their responses.

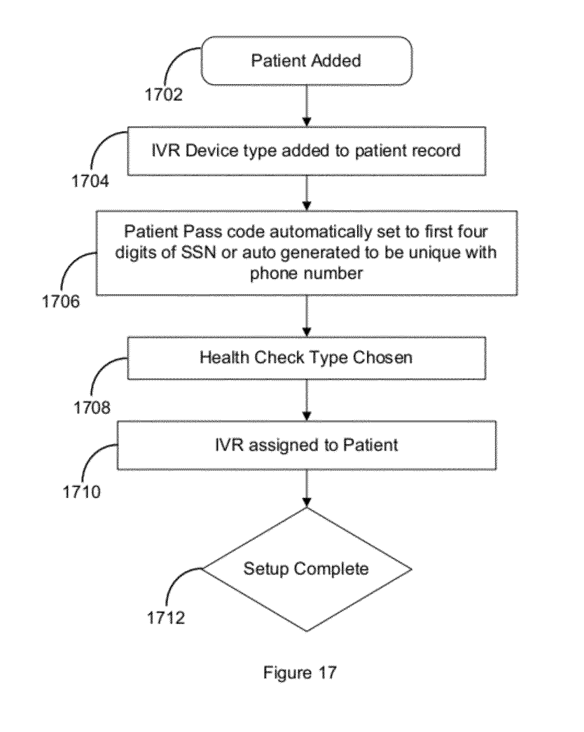

When an administrator decides to provide IVR access to a patient a patient may be set up according to the flow chart of FIG. 17. At block 1702 a patient is added to an electronic healthcare system. An administrator may add a patient to the electronic healthcare system through a web-based form. At block 1704 an IVR device type is added to the patient record. The IVR device type indicates to the electronic health care system that the patient will have access to the IVR system. At block 1706 a patient pass code is automatically assigned to the patient. According to one embodiment, the patient pass code is assigned as the last four digits of the patient's social security number (SSN). According to another embodiment, the patient pass code is automatically generated to be a unique code based on the patient's phone number.

At block 1708 a health check type is chosen. An administrator may assign a health check type to the patient to indicate to the electronic health care system a default question or set of questions to ask the patient when a call is initiated through the IVR system. For example, the health check type may be a Chronic Kidney Disease (CKD) check to ask the patient questions about symptoms related to CKD. At block 1710 the patient is activated in the IVR system. According to one embodiment, when an administrator selects an “Assign Device” button at the end of a web form the IVR device type is immediately processed and added to the patient's record in the electronic healthcare system. According to one embodiment, the request to add the IVR device type to the patient's record may be saved and provided to a supervisor for reviewing the administrator's input. At block 1712 the patient setup is complete.

Although a default pass code is provided when the IVR device type is added to a patient record, the patient or the administrator may modify the pass code. For example, after initiating a call to the IVR system the patient may change the pass code. In another example, if the patient forgets their pass code the administrator may enter the electronic health care system and recover or reset the patient's pass code.

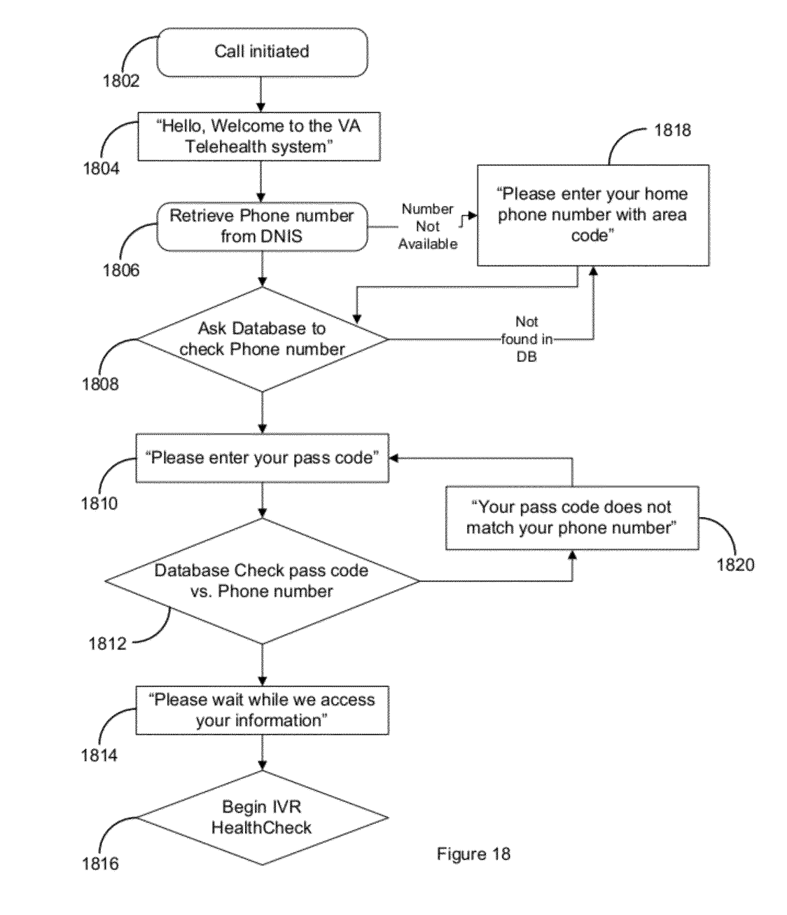

When a patient accesses the IVR system, the IVR system may use the pass code to verify the user's identity before providing access to a patient's health information or requesting information about a patient's health. FIG. 18 is a flow chart illustrating authentication of a patient in an IVR system according to an example embodiment. At block 1802 a call is initiated. The call may be initiated by either the IVR system or the patient. At block 1804 a voice prompt is provided to the patient welcoming the patient to the IVR system. The prompt may serve as a friendly greeting and an assurance to the patient that the IVR system is authentic. For example, the voice prompt may included additional information such as a secret phrase that allows the user to be confident in the security or privacy of health information provided over the telephone system by the patient.

At block 1806, the IVR system retrieves phone number information of the initiated call from the Dialed Number Identification Service (DNIS) or other caller identification system. If the number is not available the flow continues to block 1818 to prompt the patient to enter their home phone number or another phone number registered with the IVR system. According to one embodiment, a patient may respond using the touch-tone keypad. According to another embodiment, the patient may speak the phone number. The IVR system may allow a patient to enter a home phone number, work phone number, or cellular phone number stored. After the patient enters their phone number the flow continues to block 1808. At block 1808 the IVR system checks the input phone number against the database. If the phone number is not found in the IVR system the flow returns to block 1818 to again prompt the patient to enter a phone number. After a phone number entered by the patient is accepted at block 1808 the flow continues to block 1810.

If the phone number is successfully retrieved from the DNIS at block 1806 the IVR system checks the phone number against the database at block 1808. If the phone number is located in the database the flow continues to block 1810. According to one embodiment, if a call is initiated by the IVR system the blocks 1806 and 1808 may be skipped because the IVR system used a phone number from the database to initiate the call.

After the phone number information is located in the database at block 1808, the IVR system prompts the patient to enter their pass code at block 1810. At block 1812 the IVR system checks the entered pass code against the database for the phone number of the patient. If the pass code does not match the pass code on record for the phone number an error prompt is read to the patient at block 1820 and flow continues to block 1810 to allow the patient to re-enter their pass code.

When the entered pass code matches the stored pass code the flow continues to block 1814 to indicate to the patient they have gained access to the IVR system. At block 1816 a health check may begin. For example, at block 1816 the IVR system may prompt the patient with a question or series of questions based on the default health check configured by an administrator in FIG. 17.

The health check provided to the patient may include questions including yes/no questions, true/false questions, multiple choice questions, and/or numeric entry questions. The health check may be customized by an administrator to include rotating messages, custom questions, and/or branching logic to identify areas of concern for the patient when positive symptoms are reported by the patient. The branching logic questions may optimize interaction between the IVR system and patient to reduce the number of question prompts provided to the patient.

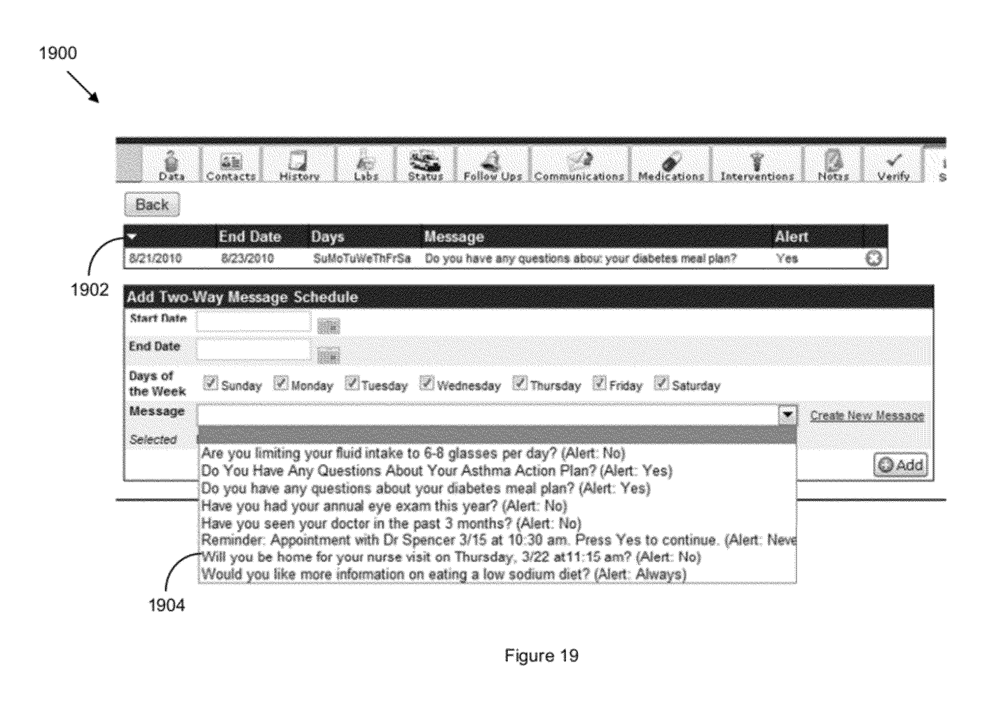

According to one embodiment, an administrator may enter a custom message for a particular patient after reviewing the patients responses to the IVR system. The custom message may be entered as text to the IVR system by the administrator in a web-based form and provided to the patient through the IVR system with a text-to-speech translator. FIG. 19 is an example screen shot of message selection for an IVR system according to an example embodiment. A screen shot 1900 may include an indication 1902 of previously configured message prompts for a patient. The screens shot may also include additional messages 1904 that may be selected by an administrator for presentation to the patient. Messages selected from the available messages 1904 may be configured for presentation to the patient on certain days of the week between a start date and an end date.

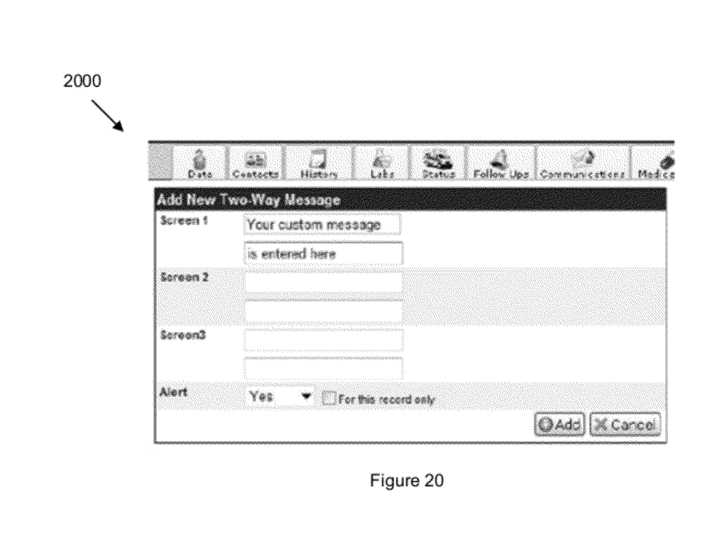

When an available message is not applicable to the patient, a custom message may be entered by the administrator. FIG. 20 is an example screen shot of custom message entry for an IVR system according to an example embodiment. A screen shot 2000 includes entry lines for custom messages. The custom message may include multiple sequential prompts entered as “Screen1,” “Screen 2,” and “Screen3.”

According to one embodiment, the IVR system may identify high risk patients through risk stratification. For example, patients who have entered outlying data and or who were non-responsive to certain questions may be flagged for an administrator's attention. At defined time periods or on a continuous basis, the IVR system may calculate numeric values for each health message in the IVR system. When the numeric values for a patient exceed a predetermined threshold the administrator may be notified to further evaluate the patient. Additionally, variance percentages may be configured to compare threshold values from one day to another day. Questions presented to a patient may be categorized as one of a standard question, an acute question, a compliance question, and/or a first response question. Categorization of questions may further increase efficiencies for an administrator managing patients and assist in identifying outlier patients.

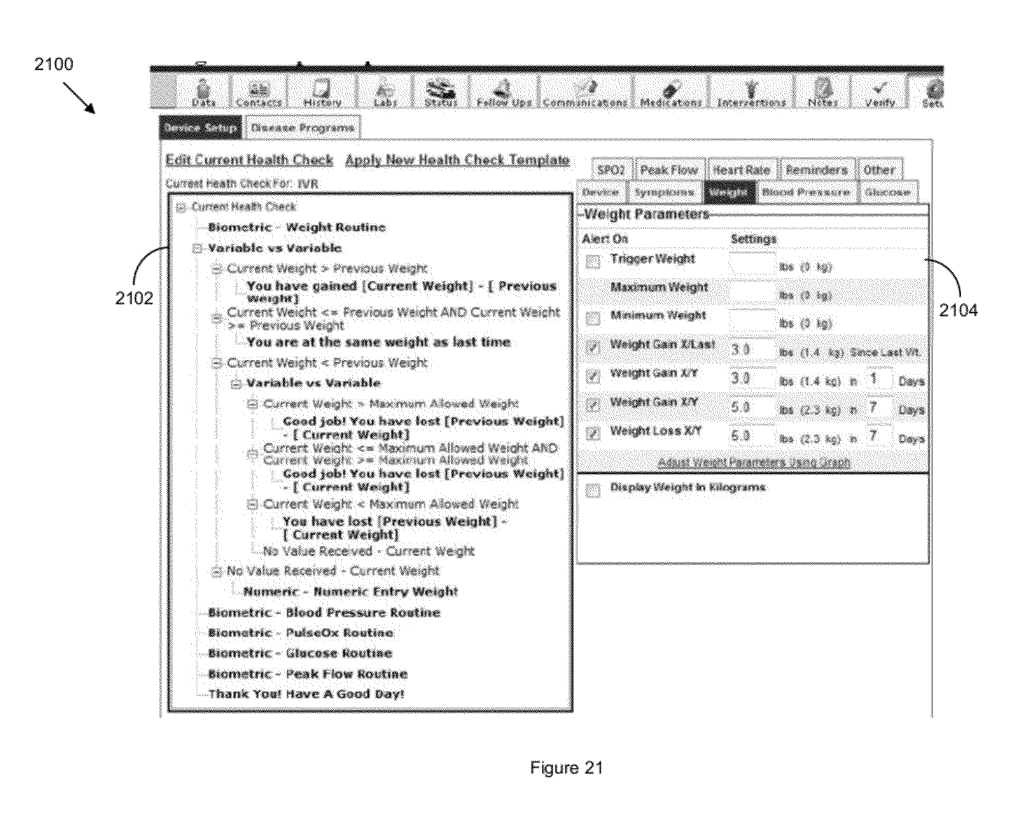

FIG. 21 is an example screen shot illustrating assignable numeric values to questions for risk stratification according to an example embodiment. A screen shot 2100 includes a display 2102 of a health check in the IVR system. The screen shot 2100 also includes a display 2104 of assignable risk parameters for the health check displayed in the display 2102. An administrator may select from a number of categories of risk parameters including SPO2, Peak Flow, Heart Rate, Reminders, Other, Device, Symptoms, Weight, Blood Pressure, and/or Glucose. When a risk parameter category is selected the administrator may select parameters for configuring alerts. For example, when the “Weight” category is selected an administrator may set alerts to trigger at a specific weight, a maximum weight, a minimum weight, and/or a weight gain/loss over a specific period of time. According to one embodiment, an administrator may set an alert to occur for a patient who gains or loses 3.0 pounds in one day or for a patient who gains or loses 5.0 pounds in seven days. The health check of the display 2102 may be configured by an administrator through a health check template item editor. Through the editor an administrator may build custom logic for combinations of messages to present to a patient. Logic flow through the messages may be controlled by the value of numeric responses and stored patient setup variables.

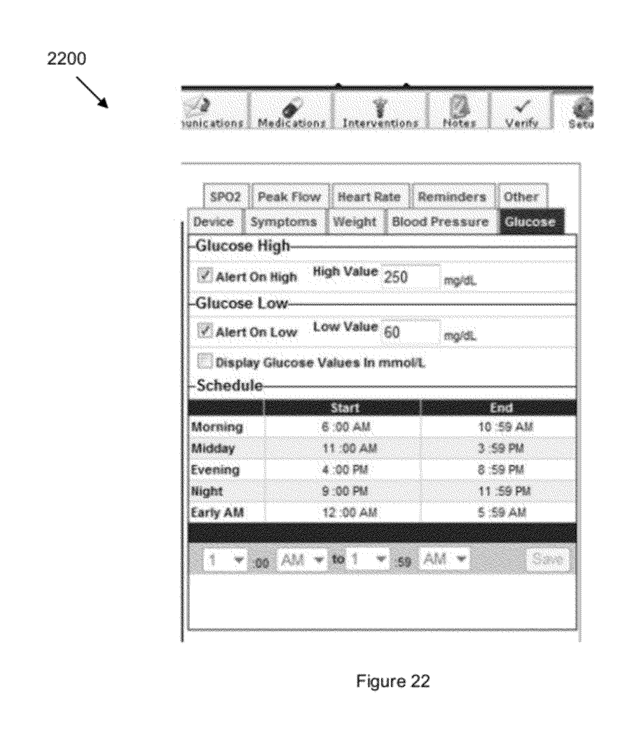

Another display for the display 2104 of FIG. 21 is illustrated in FIG. 22. FIG. 22 is an example screen shot illustrating glucose alerts configurable for patients of the IVR system according to an example embodiment. A screen shot 2200 includes configurable alerts for high and/or low glucose values for a patient. According to one embodiment, the alerts may be configured for specific periods of time. For example, separate high glucose and/or low glucose levels may be configured for morning, midday, evening, night, and/or early AM.

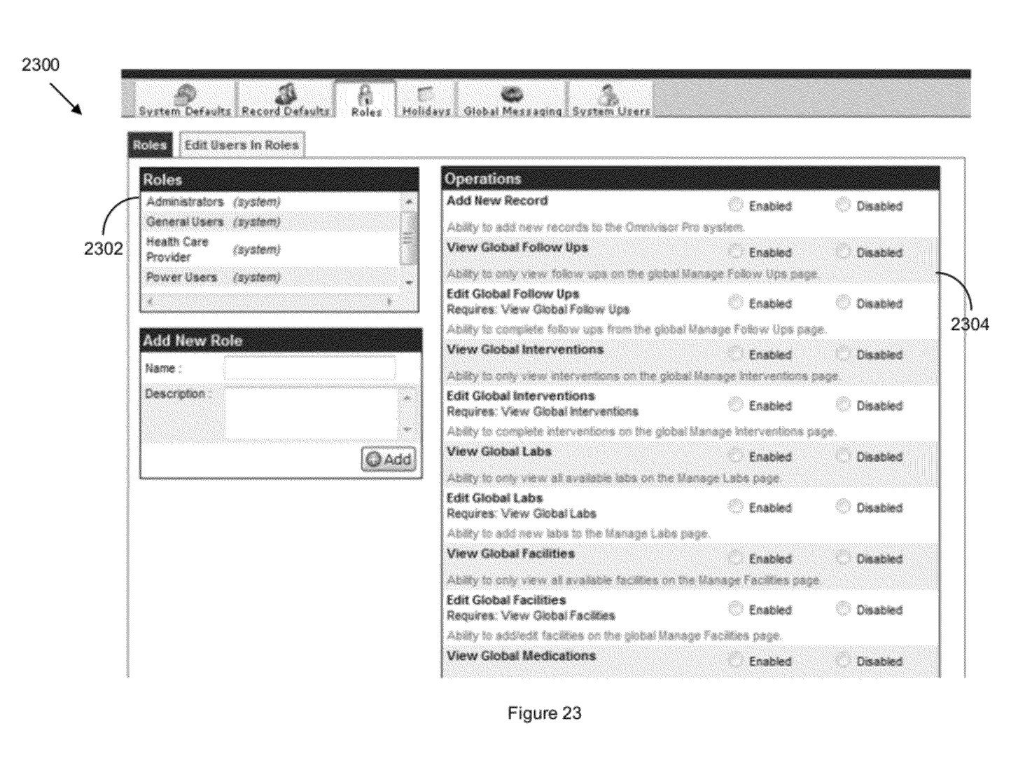

Administrators may access the electronic health care system coupled to the IVR system through, for example, web-based forms. However, different administrators may be assigned different privileges for accessing patient's information. For example, some administrators may have access to customer service functions such as resetting pass codes. In another example, clinicians may be configured as administrators with complete access to patient health information. FIG. 23 is an example screen shot illustrating configuration of administrators according to an example embodiment. Administrators may be classified into several enterprise roles illustrated in a display 2302 of a screen shot 2300. For example, enterprise roles may include administrators, general users, health care providers, and/or power users. A display 2304 may present the privilege levels of one of the enterprise roles displayed in the display 2302. For example, privileges may include adding new records, viewing global follow ups, editing global follow ups, viewing global interventions, editing global interventions, viewing global labs, editing global labs, viewing global facilities, editing global facilities, and/or viewing global medications.

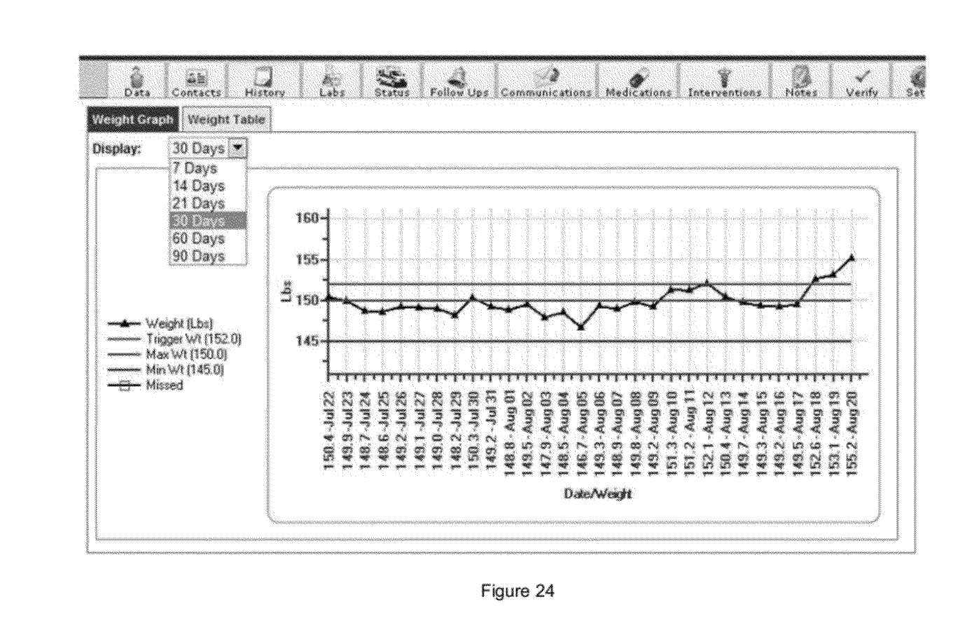

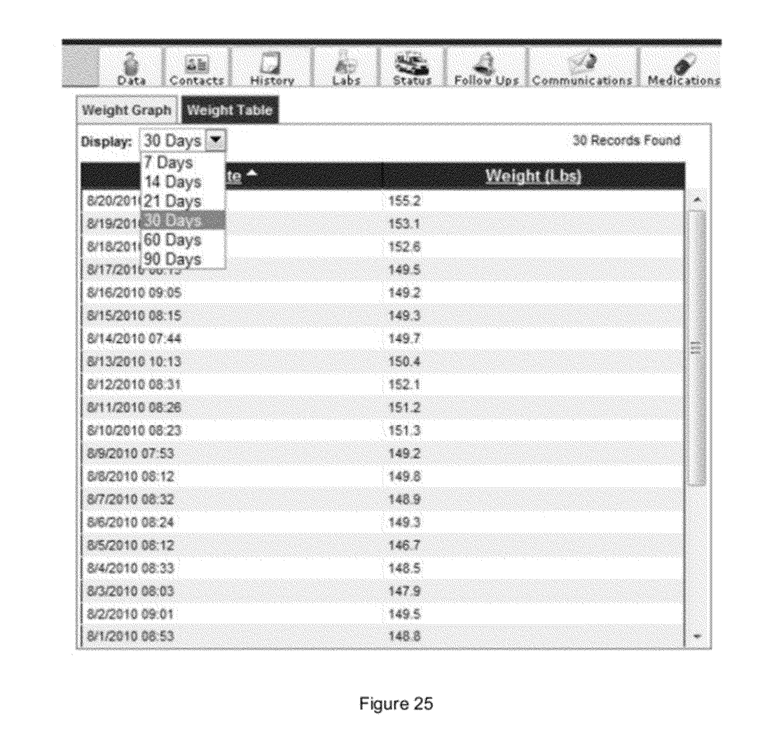

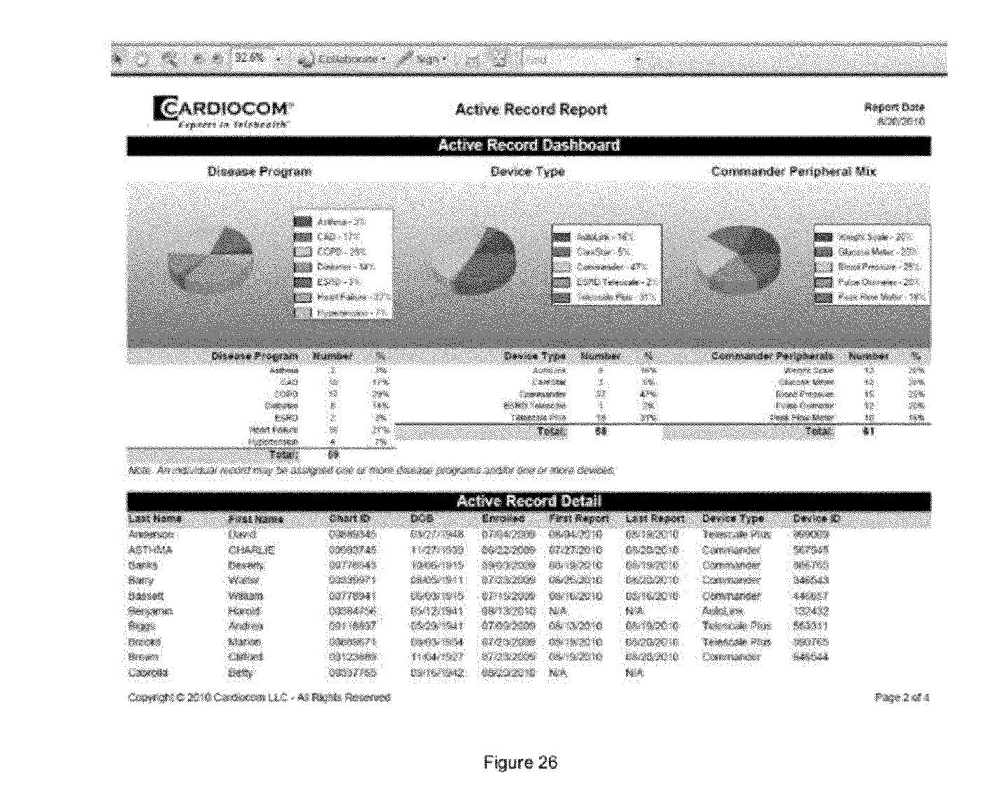

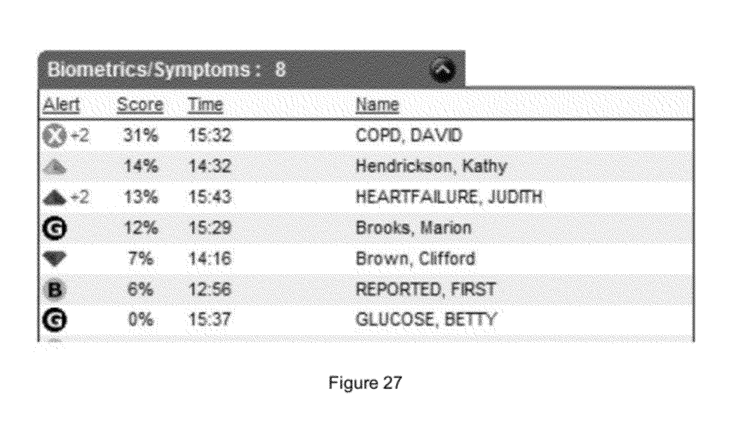

Administrators with access to patient health information may view the health information in a graph or table view. FIG. 24 is an example screen shot illustrating a graphical view of patient health information according to an example embodiment. FIG. 25 is an example screen shot illustrating a tabular view of patient health information according to an example embodiment. Administrators may also view a dashboard summary of data stored in an electronic health system including number of patients enrolled with disease programs, number of patients enrolled for various device types, and number of patients enrolled for various peripherals. FIG. 26 is an example screen shot illustrating an administrator dashboard summary according to an example embodiment. Administrators may be alerted to patients having irregular measurements or responses in an alert display. FIG. 27 is an example screen shot illustrating biometric alerts according to an example embodiment. Alerts may be represented by a graphical icon and/or a score. The graphical icon may provide the administrator with information regarding the type of alert for a patient and the score may provide a relative importance for addressing the alert.

Various embodiments provide one or more advantages. For instance, embodiments can be used to remotely monitor patients who are under treatment for HF, Hypertension, Diabetes, COPD, ESRD, CKD, and other complex chronic conditions. In some scenarios, remote monitoring with exception-based response can provide a lower-cost solution than frequent monitoring performed directly by a nurse or other health care professional. Furthermore, while the condition of a patient may change frequently, some embodiments provide a convenient and relatively inexpensive way to monitor a patient with any desired schedule. From the patient's perspective, use as directed of some embodiments may manage the patient's condition to minimize deterioration or hospitalization.

The weight measuring devices of the present invention can be used to monitor a patient that is known or suspected to have a disease or health-related condition known to be associated with weight change. The term “monitoring” as used herein refers to methods by which a healthcare provider can estimate or determine whether or not a patient with a disease or health-related condition requires a change in therapy based on the measure of a particular parameter (such as weight or blood pressure of the patient).

The terms “assessing” and “assessment” refer to methods by which a healthcare provider can monitor or determine the change in health status. The healthcare provider often makes a health status assessment on the basis of one or more vital sign or symptom status questions that is indicative of the change in the patient's condition.

A “disease” or “health-related condition” can be any pathological condition of a body part, an organ, or a system resulting from any cause, such as infection, genetic defect, and/or environmental stress. The cause may or may not be known.

In some embodiments, the weight change may be a change that is associated with volume overload or volume depletion. Volume overload refers to expansion of the extracellular volume. Non-limiting examples of diseases and conditions associated with volume overload include renal failure, heart failure, cirrhosis of the liver, nephrotic syndrome, preeclampsia, and pregnancy. Non-limiting examples of diseases and conditions associated with volume depletion include inadequate fluid intake, hemodialysis, peritoneal dialysis, diarrhea, acute renal failure, diabetes, diuretic therapy, adrenal disorders, and acute gastroenteritis.

The patient may be known or suspected to have a kidney disease. “Kidney disease”, as used herein refers to an acute or chronic injury to at least one kidney of a subject, and in particular renal tubular cell injury. Kidney injury can be confirmed by any of a number of measurable criteria known in the art, including but not limited to measurement of the level of microalbuminuria and glomerular filtration rate (GFR). The kidney disease may be CKD.

ESRD almost always follows CKD. A person with CKD may have gradual worsening of kidney function for 10-20 years or more before progressing to ESRD. Non-limiting examples of causes of ESRD (and kidney disease) include chronic infection, chronic inflammation, glomerulonephritides, vascular disease, interstitial nephritis, a drug, a toxin, trauma, a renal stone, long standing hypertension, diabetes (diabetic nephropathy), heart failure, nephropathy from sickle cell anemia and other blood dyscrasias, nephropathy related to hepatitis, HIV, cystic kidney disease, congenital malformation, obstruction, malignancy, lupus nephritis, membranous glomerulonephritis, membranoproliferative glomerulonephritis, focal glomerular sclerosis, minimal change disease, cryoglobulinemia, Anti-Neutrophil Cytoplasmic Antibody (ANCA)-positive vasculitis, ANCA-negative vasculitis, amyloidosis, multiple myeloma, light chain deposition disease, complications of kidney transplant, chronic rejection of a kidney transplant, chronic allograft nephropathy, kidney disease of indeterminate cause, and the chronic effect of immunosuppressives.

ESRD patients may require renal replacement therapy (e.g., hemodialysis, peritoneal dialysis, or kidney transplantation), drug therapy, modification of fluid intake, and/or modification of diet.

The patient with ESRD may be afflicted with or was previously afflicted with a disease other than kidney disease. In particular, the other disease can be a disease linked to or predisposing one to kidney disease. For example, in some embodiments, the subject is a diabetic subject, as diabetes can be a risk factor for developing kidney disease. In some embodiments, the subject is a diabetic subject suffering from, or at risk of suffering from, diabetic nephropathy.

In the context of the present disclosure, “weight” refers to the measured heaviness of a patient to be monitored. Unless otherwise specified herein, weight can be measured using any method or device known to a patient, a healthcare provider, or to those of ordinary skill in the field of the invention. Weight can be determined and monitored by the healthcare provider at any frequency as determined by the patient's healthcare provider, taking into account the patient's disease and individual health status. For example, patient's weight can be measured once a day, twice a day, once every two days, once every three days, once a week, twice a week, once every two weeks, once every three weeks, or once a month using the devices and methods set forth herein.

A “weight parameter” as used herein refers to a specific value of a particular parameter that is determined or ascertained by a healthcare provider. In particular embodiments it is dependent upon the clinical course and/or characteristics of the particular patient that is to be monitored. Non-limiting examples of weight parameters include dry weight (as discussed above), weight of the patient immediately after a previous session of dialysis, weight of the patient immediately prior to a previous session of dialysis, weight of the patient within 1-2 weeks prior to or after a previous session of dialysis, weight of the patient within 2-3 weeks prior to or after a previous session of dialysis, or median weight of the patient between a first dialysis session and a subsequent dialysis session. A weight parameter may also be a median or mean weight of a subject of similar height from the same or a similar population of subjects.

Some embodiments of the present invention include comparing the weight of a subject to a first weight parameter and a second weight parameter. In these embodiments, the first weight parameter is distinct from the second weight parameter.

In some embodiments, generating information relevant to a patient's disease or health-related condition involves converting the weight of the patient to a Body Mass Index (BMI). BMI is calculated from the weight and height of the patient. The BMI of the patient may then be compared to at least one of the first and second parameters.

The healthcare provider will understand that associating a change in weight of a patient relative to one or more weight parameters may signal that a subject is more likely to suffer from an adverse event and that a particular instruction to the patient is warranted. The change in weight of the patient relative to a weight parameter that may warrant a change in therapy or patient instructions may vary and largely depends on the decision of the healthcare provider and individual characteristics of the patient.

In some embodiments of the present methods, multiple determination of patient weight can be made, and a temporal change in the weight relative to one or more weight parameters can be used to monitor the progression of disease and/or efficacy of appropriate therapies directed against the disease. For example, one might expect to see a decrease or an increase in weight over time during the course of effective therapy. Thus, in addition to monitoring patients, the presently disclosed subject matter provides in some embodiments a method for determining treatment efficacy and/or progression of ESRD in a subject.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method, comprising:
initiating a call between a patient and an interactive voice response (IVR) system;
authenticating the patient on the call;
collecting data from the patient after authenticating the patient;
performing risk assessment of the patient based, in part, on the collected data.

2. The method of claim 1, in which initiating the call between the patient and the IVR system comprises the IVR system placing a telephone call to the patient.

3. The method of claim 2, in which the IVR system places the telephone call to the patient on a predefined schedule.

4. The method of claim 1, in which authenticating the patient comprises:
identifying the telephone number of the patient;
requesting the patient to enter a pass code;
verifying the pass code of the patient before collecting data from the patient.

5. The method of claim 4, in which identifying the telephone number comprises retrieving the telephone number from a Dialed Number Information Service (DNIS).

6. The method of claim 4, in which identifying the telephone number comprises requesting the patient to enter a telephone number.

7. The method of claim 4, in which requesting the patient to enter a pass code comprises requesting a patient to enter the last four digits of the patient's social security number.

8. The method of claim 1, in which collecting data from the patient comprises performing a predefined health check of the patient.

9. The method of claim 1, further comprising alerting an when a value calculated by the risk assessment exceeds a predefined threshold.

10. The method of claim 1, further comprising providing a custom message to the patient.

11. A system, comprising:
an authentication module for authenticating a patient for accessing an interactive voice response (IVR) system;
a text-to-speech module for providing prompts to the patient;
a data collection module for receiving responses to the prompts from the patient; and
a risk assessment module for evaluating the responses received by the data collection module.

12. The system of claim 11, in which the text-to-speech module provides prompts to a patient through a telephone line and the data collection module receives responses from the patient through the telephone line.

13. The system of claim 11, in which the risk assessment module calculates a numeric value for the patient based on data collected from the patient by the data collection module.

14. The system of claim 13, further comprising an alerting module for alerting an administrator when the numeric value calculated by the risk assessment module exceeds a predetermined threshold.

15. The system of claim 11, further comprising a health check module for determining prompts provided to the patient by the text-to-speech module based, in part, on responses received by the data collection module.

16. The system of claim 15, in which the health check module comprises branching logic for interactively selecting questions based, in part, on a predetermined set of questions.

17. An apparatus, comprising:
at least one processor coupled to a memory device, in which the at least one processor is configured:
to initiate a call with a patient;
to authenticate the patient;
to collect data from the patient; and
to perform risk assessment of the patient from the collected data.

18. The apparatus of claim 17, in which the at least one processor is configured to initiate the call to the patient through a telephone line from an interactive voice response (IVR) system at predetermined times.

19. The apparatus of claim 17, in which the at least one processor is configured to authenticate the patient based, in part, on a telephone number of the patient and a pass code of the patient.

20. The apparatus of claim 17, in which the at least one processor is further configured to provide custom messages to the patient.
